(19) United States
(12) Patent Application Publication
(10) Pub. No.: US 2019/0039527 A1
(43) Pub. Date: Feb. 7, 2019

(54) DEPLOYABLE COAT HANGER ASSEMBLY FOR A MOTOR VEHICLE

(71) Applicant: FORD GLOBAL TECHNOLOGIES, LLC, Dearborn, MI (US)

(72) Inventor: Joseph Walter Herman, Detroit, MI (US)

(21) Appl. No.: 15/669,620

(22) Filed: Aug. 4, 2017

(51) Int. Cl. B60R 7/10

(52) U.S. Cl. CPC B60R 7/10

(57) ABSTRACT

A coat hanger assembly includes a housing and a hanger body. The hanger body is displaceable between a stowed position within the housing and a use position projecting from the housing. The hanger body includes a stem and two arms pivotally mounted to the stem. The two arms are displaceable between a home position and a deployed position. When fully erected the coat hanger allows one to easily hang a coat or other clothing article. A related method of hanging a clothing article is also disclosed.

### TECHNICAL FIELD

This document relates generally to the motor vehicle equipment field and, more particularly, to a deployable coat hanger assembly that may be displaced between a collapsed and concealed position and a fully deployed position in a quick and efficient manner and for the benefit and advantage of the user.

### BACKGROUND

Many motor vehicles today are provided with a clothes or coat hook in some form. Such a clothes or coat hook is typically quite small and often integrated into the grab handle on the headliner above a motor vehicle door opening. Unfortunately, such a small hook of this type may not fully receive and adequately support a larger or heavier coat or other clothes item in the desired manner. For example, a coat may swing and shift as it is subjected to cornering and braking forces during the driving of a motor vehicle. Often that shifting results in a coat falling from such a small hook.

This document relates to a self-contained and deployable coat hanger assembly with opposed displaceable arms that may be deployed to form a full coat hanger better suited for supporting and reliably holding a larger or heavier coat during motor vehicle operation. Advantageously, the coat hanger assembly may also be collapsed and concealed within an aesthetically pleasing housing when not in use.

### SUMMARY OF THE INVENTION

In accordance with the purposes and benefits described herein, a coat hanger assembly is provided. That coat hanger assembly comprises a housing and a deployable hanger body. The deployable hanger body includes a stem and two displaceable arms carried on the stem.

The housing may include a guide track and the stem may include a guide track follower engaged in the guide track. Further, the housing may include an integral snap lock feature that engages the guide track follower and releasably holds the deployable hanger body in a stowed position within the housing when not in use.

The coat hanger assembly may be said to comprise a housing and a hanger body that is displaceable between a stowed position within the housing and a use position projecting from the housing. The hanger body may include a stem and two arms pivotally mounted to the stem. Those two arms are displaceable between a home position and a deployed position.

The housing may include a guide track. The stem may include a proximal end and a distal end. A guide track follower may be provided at the proximal end of the stem. Two pivots may be provided at the distal end of the stem pivotally connecting the two arms to the stem.

The two arms may rest alongside the stem in the home position and project in opposed directions from the stem in the deployed position. The coat hanger assembly may further include a stop feature to hold the two arms in that deployed position. In addition the housing may further include an integral snap lock feature to hold the hanger body in the stowed position.

A tab may be provided on the distal end of the stem. In addition the housing may include an open end in communication with the guide track. Further, a notch receiver may be provided in the housing adjacent the open end. When the hanger body is held in the stowed position by the snap feature, the tab on the distal end of the stem may be received in the notch receiver of the housing adjacent the open end.

In accordance with an additional aspect, a method is provided of hanging a clothing article. That method comprises the steps of displacing a hanger body from a stowed position within a housing to a deployed position projecting from the housing and deploying two arms on the hanger body to receive and hold the clothing article.

The method may further include the step of sliding the hanger body along a guide track formed in the housing in order to displace the hanger body from the stowed position to the deployed position. Further, the method may include pivoting a first arm of the two arms in a first direction in order to deploy the first arm from a first home position into a first deployed position. In addition the method may include the step of pivoting a second arm of the two arms in a second direction in order to deploy the second arm from a second home position to a second deployed position.

Still further, the method may include the step of hanging a clothing article, such as a coat, from the two arms. In addition the method may include the step of returning the two arms to the home position and returning the hanger body to the stowed position within the housing following use.

In the following description, there are shown and described several preferred embodiments of the coat hanger assembly as well as the related method of hanging a clothing article. As it should be realized, the coat hanger assembly and related method are capable of other, different embodiments and their several details are capable of modification in various, obvious aspects all without departing from the coat hanger assembly and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the coat hanger assembly and together with the description serve to explain certain principles thereof.

FIG. 1a is a detailed perspective view of the coat hanger assembly illustrating the deployable hanger body of that assembly in the stowed position.

FIG. 1b is a view similar to FIG. 1a but illustrating the deployable hanger body in the use position with the two displaceable arms carried on the stem of the hanger body in the home position.

FIG. 1c is a view similar to FIGS. 1a and 1b illustrating the coat hanger assembly in the fully deployed: that is, with the stem of the deployable hanger body in the use position and the two arms of the hanger body in the deployed position.

FIG. 2 is a detailed perspective view illustrating one side of the guide track and integral snap feature adapted to hold the hanger body in the stowed position within the housing.

FIG. 3 is a side elevational view of the same structure and more clearly showing one side of the guide track in detail.

FIG. 4a is a detailed elevational view of the deployable hanger body illustrating the two arms in the home position resting alongside opposite sides of the stem.

FIG. 4b is a detailed view of the deployable hanger body similar to FIG. 4a but showing the arms in the partially-deployed position.

FIG. 4c is a detailed view similar to FIGS. 4a and 4b but showing the arms in the fully deployed position with the arms in full engagement with the stop feature that holds the arms in the deployed position and allows those arms to bear the weight of the coat or other article to be hung on the coat hanger assembly.

Reference will now be made in detail to the present preferred embodiments of the coat hanger assembly, examples of which are illustrated in the accompanying drawing figures.

### DETAILED DESCRIPTION

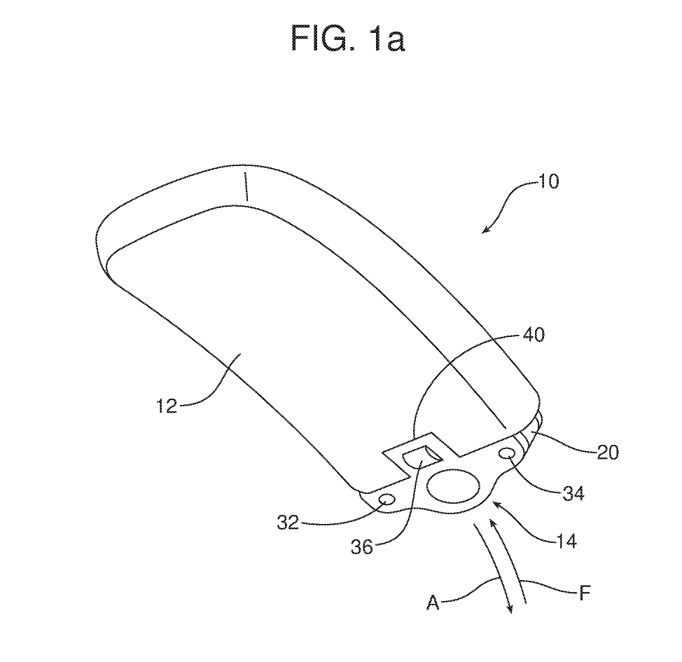

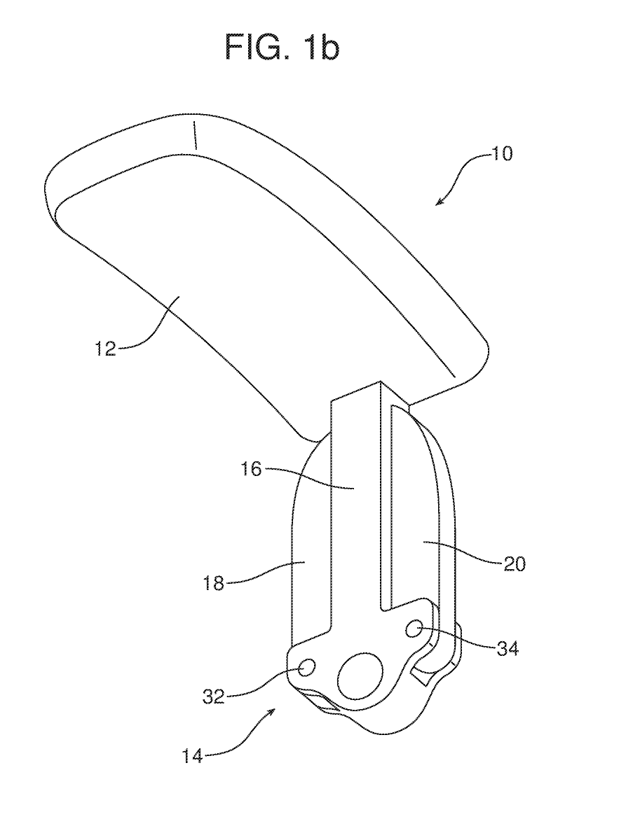

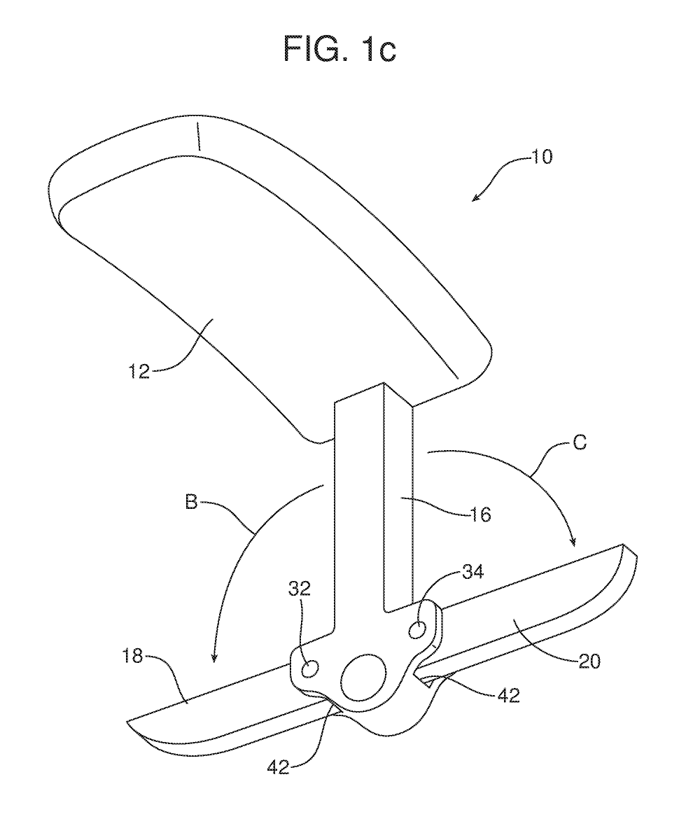

Reference is now made to FIGS. 1a-1c, 2, 3 and 4a-4c illustrating a new and improved coat hanger assembly 10. In the illustrated embodiment, the coat hanger assembly 10 is self-contained and may be easily displaced between a fully stowed configuration illustrated in FIG. 1a and a fully deployed configuration illustrated in FIG. 1c. In the fully stowed configuration, the coat hanger assembly 10 is both compact and aesthetically pleasing. In the fully deployed position illustrated in FIG. 1c, the coat hanger assembly 10 is configured to much better hold a bulky or heavy coat or other article than a simple small hook of the type commonly provided in a motor vehicle for that purpose.

The coat hanger assembly 10 includes a housing 12 and a deployable hanger body 14. The hanger body 14 includes a stem 16 and two displaceable arms 18, 20 carried on the stem. More specifically, the stem 16 includes a proximal end 26 and a distal end 28. A guide follower 30 is provided at the proximal end 26 of the stem 16. Two pivots 32, 34 are provided at the distal end 28 of the stem 16. The first arm 18 is connected to the stem 16 by the first pivot 32. The second arm 20 is connected to the stem 16 by the second pivot 34. Note the apertures 33 in the stem 16 and the first arm 18 to receive the first pivot 32 and the apertures 35 in the stem and the second arm 20 to receive the pivot 34.

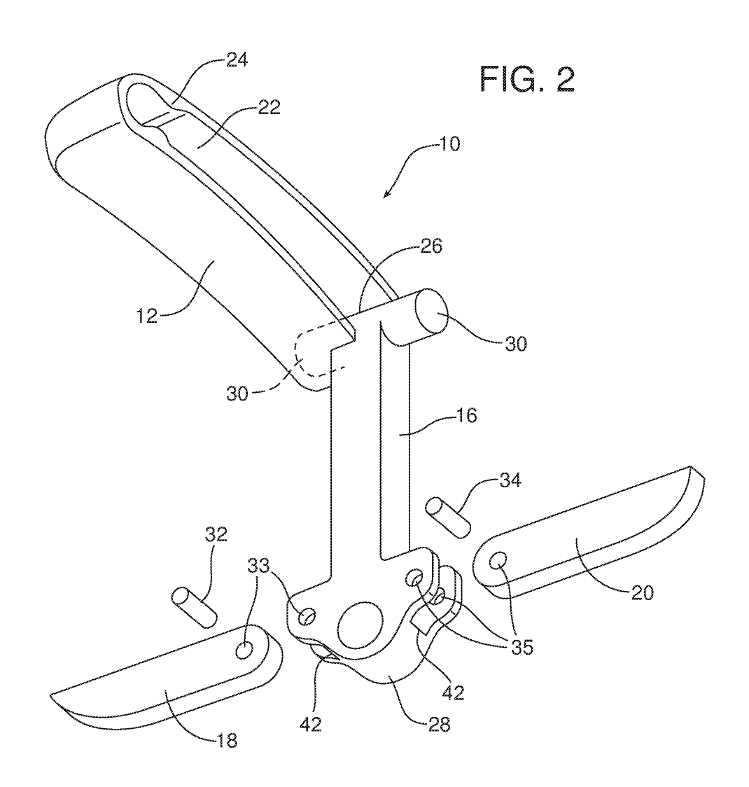

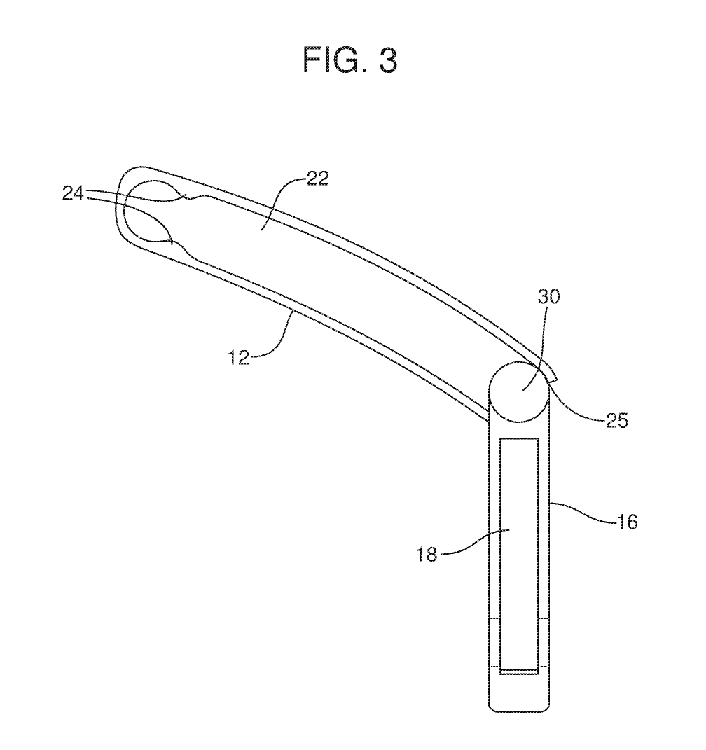

As best illustrated in FIGS. 2 and 3, the housing 12 includes an internal guide track 22. An integral snap lock feature 24 at the closed end of the guide track 22 functions to engage the guide follower 30 on the proximal end 26 of the stem 16 and hold the stem in the stowed position illustrated in FIG. 1a. The stem 16 projects or extends from the open end 25 of the guide track 22 in the housing 12 when in the use position illustrated in FIGS. 1b and 1c.

One hangs a clothing article on the coat hanger assembly 10 by displacing the hanger body 14 from a stowed position within the housing 12 (see FIG. 1a) to a use position projecting from the housing (see FIG. 1b) and deploying the two arms 18, 20 on the hanger body to receive and hold the clothing article (see FIG. 1c). Thus, one may engage the tab 36 at the distal end of the stem 16 with a finger and slide the hanger body 14 in the direction of action arrow A until the hanger body 14 is fully displaced from the stowed position within the housing shown in FIG. 1a to the use position projecting from the housing shown in FIG. 1b. Note the notch 40 in the housing 12 at the open end 25 of the guide track 22 that accommodates the tab 36 when the stem 16 is fully retracted within the housing 12. Here it should be appreciated that the latching force provided by the snap lock feature 24 is sufficient to maintain the hanger body 14 in the stowed position but easily overcome when an individual provides an appropriate displacement force by means of the tab 36.

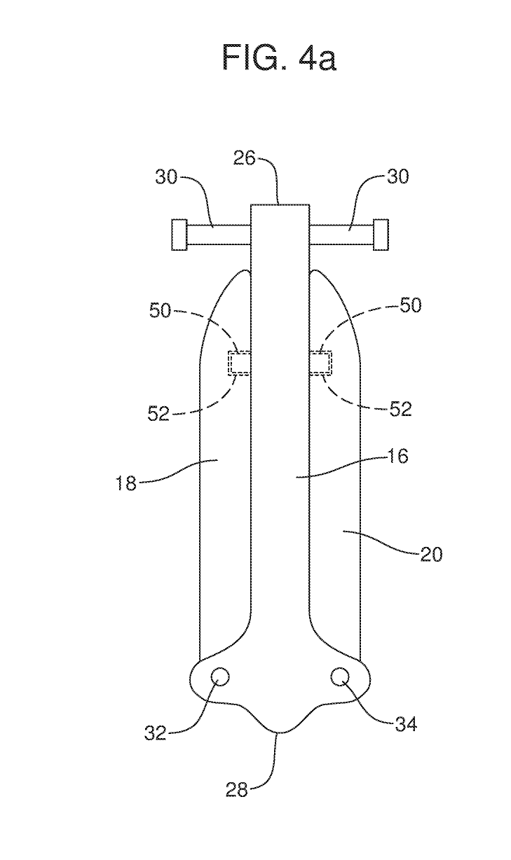

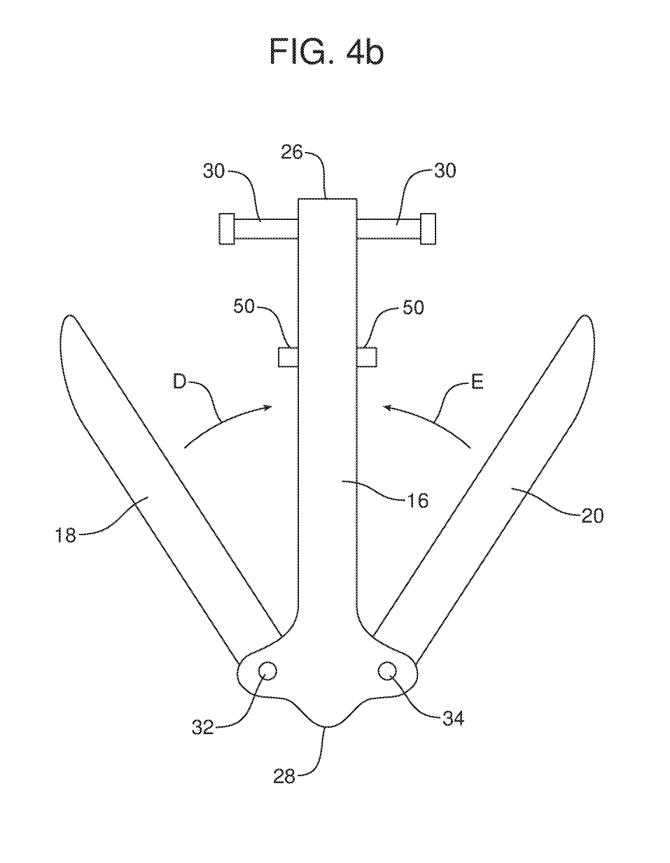

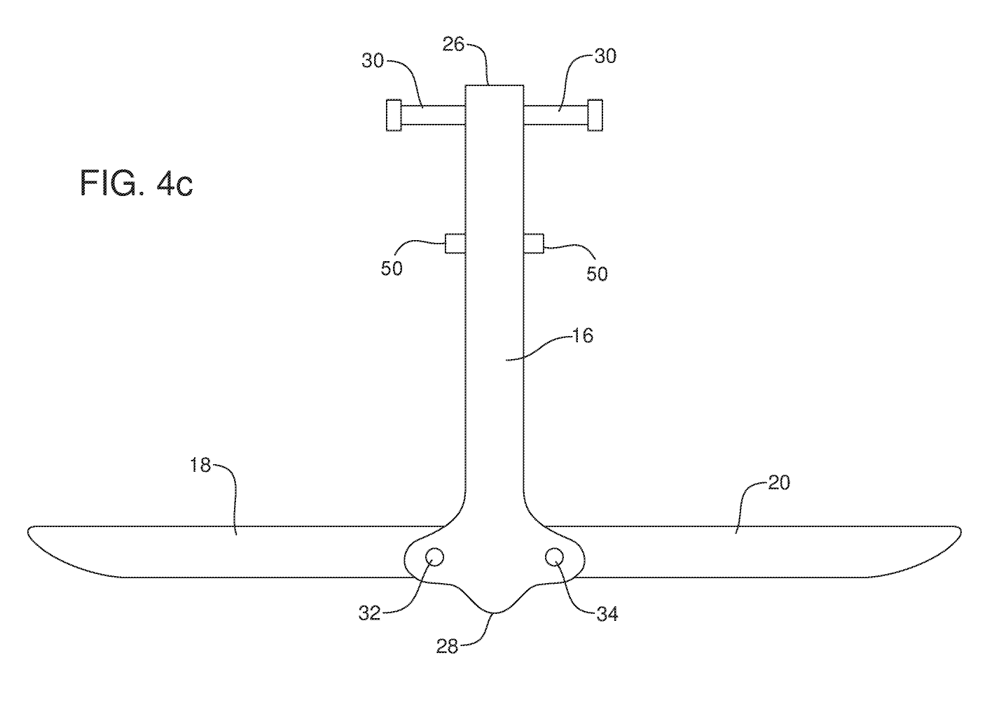

Next one deploys the two arms 18, 20. This is done by pivoting the first arm 18 in the direction of action arrow B and the second arm 20 in the direction of action arrow C in FIG. 1c. When fully deployed as illustrated in FIGS. 1c and 4c, the two arms 18, 20 are in engagement with the stop feature 42 in the form of a shoulder provided at the distal end 28 of the stem 16. The stop feature 42 holds the two arms 18, 20 in the fully deployed position and prevents them from pivoting further even under the weight of a coat or other article.

After sliding the hanger body 14 along the guide track 22 into the use position and deploying the two arms 18, 20 into the deployed position as illustrated in FIGS. 1a-1c and described above, one hangs a clothing article (not shown) on the two arms in the same manner one would hang a clothing article onto a clothes hanger as used in a closet or on a coat rack.

After use, one returns the two arms 18, 20 to the home position and returns or slides the hanger body 14 back into the stowed position. Toward this end one pivots the first arm 18 about the first pivot 32 in the direction of action arrow D and the second arm 20 about the second pivot 34 in the direction of action arrow E (see FIG. 4b) until the two arms are in the home position resting alongside the stem 16 as illustrated in FIGS. 1b and 4a. Next the individual pushes the hanger body 14 in the direction of action arrow F (see FIG. 1a) so that the guide follower 30 slides along the internal guide track 22 of the housing 12. When the hanger body 14 is fully seated within the housing 12, the integral snap lock feature 24 engages and holds the hanger body 14 in the stowed position with the tab 36 received in the notch receiver 40 of the housing 12.

The foregoing has been presented for purposes of illustration and description. It is not intended to be exhaustive or to limit the embodiments to the precise form disclosed. Obvious modifications and variations are possible in light of the above teachings. For example, the tab 36 provided for engagement with a finger may be replaced by another structure such as a ring or loop. The tab 36 may also be softly illuminated if desired to aid one in locating the tab in low light ambient environment. Further, as illustrated in FIGS. 4a-4c the stem 16 may include opposed detents 50 that engage in cooperating receivers or apertures 52 in the arms 18, 20 and function to retain the arms in the home position when pushing the stem back into the housing 12. All such modifications and variations are within the scope of the appended claims when interpreted in accordance with the breadth to which they are fairly, legally and equitably entitled.

1. A coat hanger assembly in a motor vehicle, comprising:
a housing; and
a deployable hanger body including a stem and two displaceable arms carried on said stem.

2. The coat hanger assembly of claim 1, wherein said housing includes a guide track and said stem includes a guide track follower engaged in said guide track.

3. The coat hanger assembly of claim 2, wherein said housing includes an integral snap lock feature engaging said guide track follower and releasably holding said deployable hanger body in a stowed position within said housing.

4. A coat hanger assembly in a motor vehicle, comprising;
a housing; and
a hanger body displaceable between a stowed position within said housing and a use position projecting from said housing;
wherein said hanger body includes a stem and two arms pivotally mounted to said stem, said two arms being displaceable between a home position and a deployed position.

5. The coat hanger assembly of claim 4, wherein said housing includes a guide track.

6. The coat hanger assembly of claim 5, wherein said stem includes a proximal end and a distal end.

7. The coat hanger assembly of claim 6, further including a guide track follower at said proximal end of said stem.

8. The coat hanger assembly of claim 7, further including two pivots at said distal end of said stem for said two arms.

9. The coat hanger assembly of claim 8, wherein said two displaceable arms rest alongside said stem in said home position and project in opposed directions from said stem in said deployed position.

10. The coat hanger assembly of claim 9, further including a stop feature to hold said two arms in said deployed position.

11. The coat hanger assembly of claim 10, wherein said housing further includes an integral snap lock feature to hold said hanger body in said stowed position.

12. The coat hanger assembly of claim 11, further including a tab on said distal end of said stem.

13. The coat hanger assembly of claim 12, wherein said housing includes an open end in communication with said guide track.

14. The coat hanger assembly of claim 13, further including a notch receiver in said housing adjacent said open end.

15. A method of hanging a clothing article in a motor vehicle, comprising:
displacing a hanger body from a stowed position within a housing to a use position projecting from said housing; and
deploying two arms carried on a stem of said hanger body to receive and hold said clothing article.

16. The method of claim 15, including sliding said hanger body along a guide track formed in said housing in order to displace said hanger body from said stowed position to said use position.

17. The method of claim 16, including pivoting a first arm of said two arms in a first direction in order to deploy said first arm from a first home position into a first deployed position.

18. The method of claim 17, including pivoting a second arm of said two arms in a second direction in order to deploy said second arm from a second home position to a second deployed position.

19. (canceled)

20. The method of claim 18, including returning said two arms to said home position and returning said hanger body to said stowed position.
